(19) United States
(12) Patent Application Publication
(10) Pub. No.: US 2014/0202544 A1
(43) Pub. Date: Jul. 24, 2014

(54) Fitting For Changing Liquid Paths

(71) Applicants: Ralf Diederich, Worms (DE); Wolfgang Kochanowski, Windesheim (DE); Stefan Schaefer, Heppenheim (DE); Gerhard Schwarz, Dackenheim (DE); Peter Hartmann, Frankenthal (DE)

(72) Inventors: Ralf Diederich, Worms (DE); Wolfgang Kochanowski, Windesheim (DE); Stefan Schaefer, Heppenheim (DE); Gerhard Schwarz, Dackenheim (DE); Peter Hartmann, Frankenthal (DE)

(73) Assignee: KSB Aktiengesellschaft, Frankenthal (DE)

(21) Appl. No.: 14/126,702

(22) PCT Filed: Jun. 13, 2012
(86) PCT No.: PCT/EP2012/061162

§ 371 Date: Mar. 21, 2014

(30) Foreign Application Priority Data
Jun. 17, 2011 (DE) 10 2011 077 679.6
Jun. 12, 2012 (DE) 10 2012 209 793.7

(51) Int. Cl. F16K 1/52

(52) U.S. Cl. CPC F16K 1/526
USPC 137/1; 137/613

(57) ABSTRACT

A fitting for changing liquid paths, in particular for systems with a pressure exchanger, is provided. The pressure exchanger has pipes having alternating flow direction. The casing of the fitting includes an inlet piece, an outlet piece and a connection piece and at least one shut-off member connected to an actuator. The actuator is connected to a control device that controls the actuator to control a liquid flow between the inlet piece and the connection piece, or between the connection piece and the outlet piece. An actuator displaces a respective shut-off member arranged in each of the inlet piece and the outlet piece, with the shut-off members being axially displaceable to vary the size of flow openings that permit flow between the inlet piece and the connection piece or between the connection piece and the outlet piece.

### CROSS REFERENCE TO RELATED APPLICATIONS

This application is a continuation of PCT International Application No. PCT/EP2012/061162, filed Jun. 13, 2012, which claims priority under 35 U.S.C. §119 from German Patent Application No. 10 2011 077 679.6, filed Jun. 17, 2011, and German Patent Application No. 10 2012 209 793.7, filed Jun. 12, 2012, the entire disclosures of which are herein expressly incorporated by reference.

### BACKGROUND AND SUMMARY OF THE INVENTION

The invention relates to a fitting for changing liquid paths, in particular for systems with a pressure exchanger which has pipes having alternating flow direction, with a casing that comprises an inlet piece, an outlet piece, and a connection piece for a pipe, the fitting having at least one shut-off member that is connected to an actuator which is connected to a control device that is designed to produce a liquid flow between the inlet piece and the connection piece, or between the connection piece and the outlet piece.

Such a fitting is used in pressure exchangers, for example as are used in seawater desalination systems in accordance with the reverse osmosis method. Here, a seawater flow is conveyed under high pressure to membrane modules. Pure water is pressed through the membrane, whereas the salt dissolved in the water is retained. The portion flowing through is referred to as the permeate flow, whereas the retained portion is referred to as the retentate flow.

The retentate flow is enriched with salts and still has a high pressure. This is used by means of a pressure exchanger. Pressure exchangers consist of at least two pipelines. A displaceable partition member may be arranged within the pipes. At the start of a cycle, the first pipe is filled with seawater. The partition member is located at one end of the pipe. The high-pressure retentate is then fed. The seawater and the high-pressure retentate are separated by the partition member. The high-pressure retentate pushes the seawater from the pipe and conveys it to the membrane modules. In doing so, the high-pressure retentate releases its pressure and becomes a low-pressure retentate.

Whilst this process occurs in the first pipe, the following processes take place in the second pipe: the second pipe is initially filled with low-pressure retentate. Seawater is then fed to the second pipe. Seawater and low-pressure retentate are separated by a partition member. The seawater pushes the low-pressure retentate from the second pipe.

With periodic change, high-pressure retentate thus flows in one pipe, whereas seawater flows in the other pipe.

The changeover process occurs with generic fittings on which specific requirements are placed. The connection piece is operated in alternating flow directions, wherein the high-pressure liquid during the first cycle flows in via the inlet piece and on to the connection piece, and the low-pressure liquid during the second cycle flows in via the connection piece and on to the outlet piece.

Such a changeover process, in which a connection is operated in alternating flow directions, cannot be ensured with conventional multi-path fittings, as are described for example in WO 2010/091988 A1. Due to their switching logic and their construction, they cannot be used in pressure exchangers in seawater desalination systems. A fitting with a casing made of plastic is described in WO 2010/091988 A1. The fitting is used in coffee machines at flow rates of 400 mL/min and a maximum operating pressure of 2.5 bar. The fitting has an inlet channel and three outlet channels. The inlet channel is connected to one of the outlet channels via the activation of solenoid valves.

By contrast, a fitting that is suitable for use in pressure exchangers in seawater desalination systems is described in WO 2004/080576 A1. With this fitting, a rotatable control element is arranged within a casing and is driven by a motor via a drive shaft.

When changing the liquid flows, pressure impulses occur and damage the membranes of the reverse osmosis systems.

A fitting for changeover with few pressure impulses is described in DE 103 10 662 A1. A flow divider is located within a casing of the fitting. A rotating disk-shaped control element is arranged on each end face of the flow divider.

WO 2010/141013 A1 describes a reverse osmosis system with a pressure exchanger in which a disk valve is used as a flow divider.

Such fittings are of very complex construction and are accordingly costly. Furthermore, only an even of number of pipes of a pressure exchanger can be operated with these fittings.

Furthermore, JP 2010253344 A discloses a reverse osmosis system in which the pure open/close valves leading to or away from the pressure exchanger are arranged in the lines and are formed as sliding valves.

On this technical basis, the object of the invention is to provide a fitting having the features described in the introduction, which is cost-effective and enables liquid flows to be changed with few pressure impulses. With the fitting, it should also be possible to operate an odd number of pipes in pressure exchangers. In addition, reliable operation with low maintenance effort is to be ensured. Furthermore, the shut-off members are to be easily operable, even at high counterpressure. By use of these fittings, a clear and compact design of a pressure exchanger for a reverse osmosis system is to be ensured.

This object is achieved in accordance with the invention in that a shut-off member is arranged in each of the inlet piece and the outlet piece and said shut-off members are axially displaceable to vary the size of flow openings.

In accordance with the invention, a fitting is attached to one side of the pressure exchanger and, within a casing, has two axially displaceable shut-off members. Each shut-off member is preferably connected to a separate actuator.

The changeover process occurs by axial displacement of the shut-off members which are arranged in the inlet piece and in the outlet piece of the casing. In contrast to rotating changeover systems, the fitting according to the invention is constructed much more clearly and can thus be produced cost-effectively. In addition, a changeover process experiencing particularly few pressure impulses is produced. The fitting additionally functions largely without interference, such that only a low maintenance effort is necessary. With the fittings according to the invention, pressure exchangers having an odd number of pipes can also be operated.

In accordance with the invention, the fitting is not a pure switching fitting, in which a distinction is made merely between a fully open or fully closed state, but is a regulating fitting, which, besides the pure changeover, enables a regulation of the liquid flow. Pressure impulses are thus considerably reduced.

In a particularly advantageous embodiment of the invention, the casing is a one-piece part, in particular a cast part, which is formed by the inlet piece, the outlet piece, and the connection piece. These pieces are preferably connectors that are integrally formed on the casing. The inlet connector and the connection connector are formed in one piece with the casing.

The fitting is operated in periodic cycles.

In the first cycle, the flow-through opening in the outlet piece is fully closed. During a first phase, the shut-off member in the inlet piece opens. The flow-through opening in the inlet piece becomes larger until it is fully open. During a second phase, the flow opening in the inlet piece remains fully open. During a third phase, the shut-off member in the inlet piece closes. The size of the flow opening in the inlet piece reduces.

In the second cycle, the flow opening in the inlet piece is fully closed. During a first phase, the shut-off member of the outlet piece opens. The flow opening in the outlet piece enlarges. During a second phase, the flow opening of the outlet piece is fully open. During a third phase, the shut-off member of the outlet piece closes. The flow opening in the outlet piece reduces.

In a particularly advantageous embodiment of the invention, the actuators are controlled by the control device such that, as a flow opening is opened and/or closed, the actuation speed initially rises with a predefinable gradient and then continues with constant actuation speed. Pressure impulses are thus reduced.

In an advantageous embodiment of the invention, a component is attached to the inlet piece. The flow opening is formed between the inlet piece of the casing and the component. The shut-off member is guided during its axial displacement by the casing and/or the component. As the flow opening is closed and opened, the liquid flows perpendicular to the movement of the shut-off member.

Additionally or alternatively thereto, a component may also be joined to the outlet piece. The flow opening is formed between the component and the outlet piece of the casing. This component preferably carries the actuator of the shut-off member. As a result of axial displacement of the shut-off member, the size of the flow opening is varied, wherein the shut-off member is guided during its axial displacement by the casing and/or the component. The liquid flows radially to the direction of displacement, such that the shut-off member moves perpendicular to the liquid flow.

The shut-off member in the inlet piece is preferably cylindrical. The component attached to the inlet piece comprises a hollow-cylindrical guide element, which projects into the inlet piece. The guide element is closed toward the inflow direction, such that the guide element is formed in a beaker-like manner. The cylindrical shut-off member displaces during opening and closing in the hollow-cylindrical guide element.

If the shut-off member closes the flow opening in the inlet piece, the retentate thus acts perpendicularly on the outer lateral surface of the cylindrical shut-off member. This facilitates the opening process, since, in contrast to conventional fittings, no force acts in the movement direction of the shut-off member, but perpendicular thereto.

In the outlet piece, the hollow-cylindrical guide element is formed by the casing itself. The shut-off member is likewise cylindrical and moves in the hollow-cylindrical guide element. The guide element is closed toward the inflow direction, such that the guide element is formed in a beaker-like manner. A component is attached to the outlet piece. The shut-off member is operated by means of an actuator.

If the shut-off member closes the outlet piece, the retentate thus acts perpendicular to the outer lateral surface of the cylindrical shut-off member. This facilitates the opening of the shut-off member since, in contrast to conventional fittings, no force acts in the movement direction of the shut-off member, but perpendicular thereto.

The inlet piece and the outlet piece are preferably oriented at an angle of 90° to one another.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a perspective illustration of a fitting with a view of the connection piece in accordance with an embodiment of the present invention.

FIG. 2 shows a perspective illustration of the fitting of FIG. 1 with a view of the actuator of the outlet piece.

FIG. 3 shows a plan view of the fitting of FIG. 1.

FIG. 4 shows a front view of the fitting of FIG. 1.

FIG. 5 shows a section along the line B-B in FIG. 4.

FIG. 6 shows a schematic illustration of a seawater desalination system in accordance with an embodiment of the present invention.

FIG. 7a shows a side view of the pressure exchanger of a seawater desalination system having a fitting in accordance with an embodiment of the present invention.

FIG. 7b shows a plan view of the pressure exchanger of a seawater desalination system of FIG. 7a.

FIG. 8 shows a perspective sectional illustration of the fitting of FIG. 1.

FIG. 9 shows an enlarged illustration of the outlet piece of the fitting of FIG. 8.

### DETAILED DESCRIPTION OF THE DRAWINGS

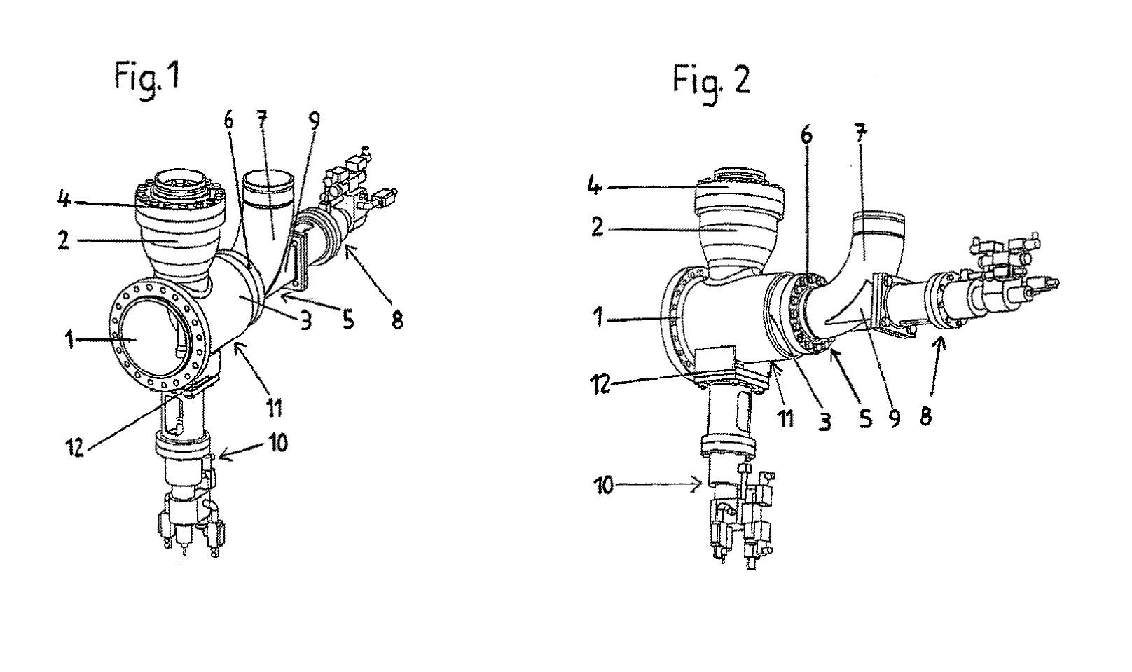

FIG. 1 and FIG. 2 show perspective views of a fitting 28 for changing liquid flows. Such a fitting 28 with a control device is used to change liquid paths, for example in a pressure exchanger 29 of a seawater desalination system in accordance with the reverse osmosis method.

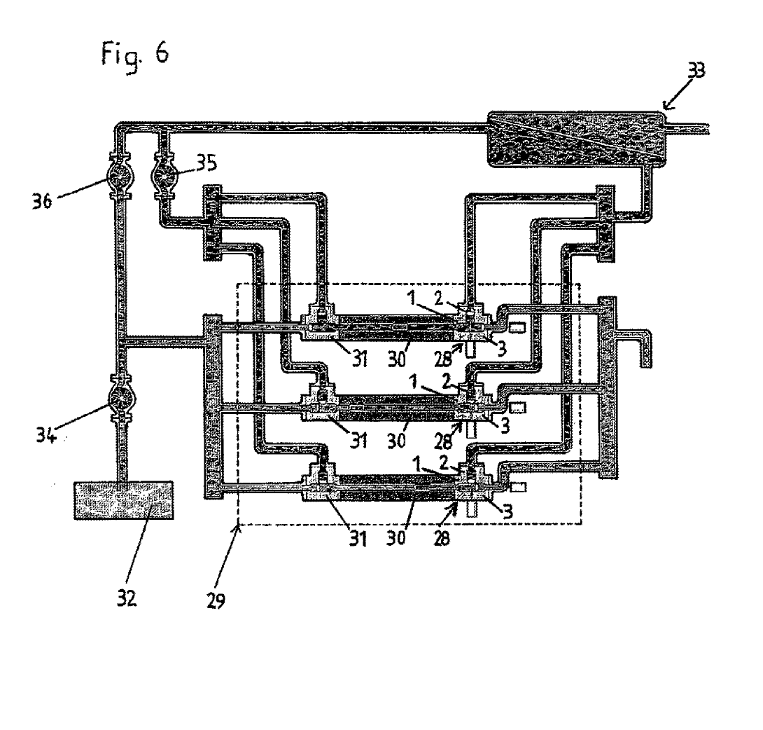

FIG. 6 shows that a pressure exchanger 29 comprises pipes 30, wherein, with periodic change, high-pressure retentate flows in one pipe 30 and seawater flows in at least one other pipe 30.

Each pipe 30 is connected at one end via the connection piece 1 to the fitting 28. The high-pressure retentate that leaves the membrane module 33 is conveyed through the inlet piece 2. Once the liquid has transferred its pressure, it is carried away as low-pressure retentate through the outlet piece 3.

FIG. 1 and FIG. 2 show that a component 4 is attached to the inlet piece 2 via a flange connection. The component 5 comprises a flange 6, to which a 90° pipe bend 7 is welded. The pipe bend 7 carries a hydraulic actuator 8, which is secured by means of a holding arrangement 9. The holding arrangement 9 is welded to the pipe bend 7.

A further hydraulic actuator 10 is secured directly to the casing 11 via a holding arrangement 12.

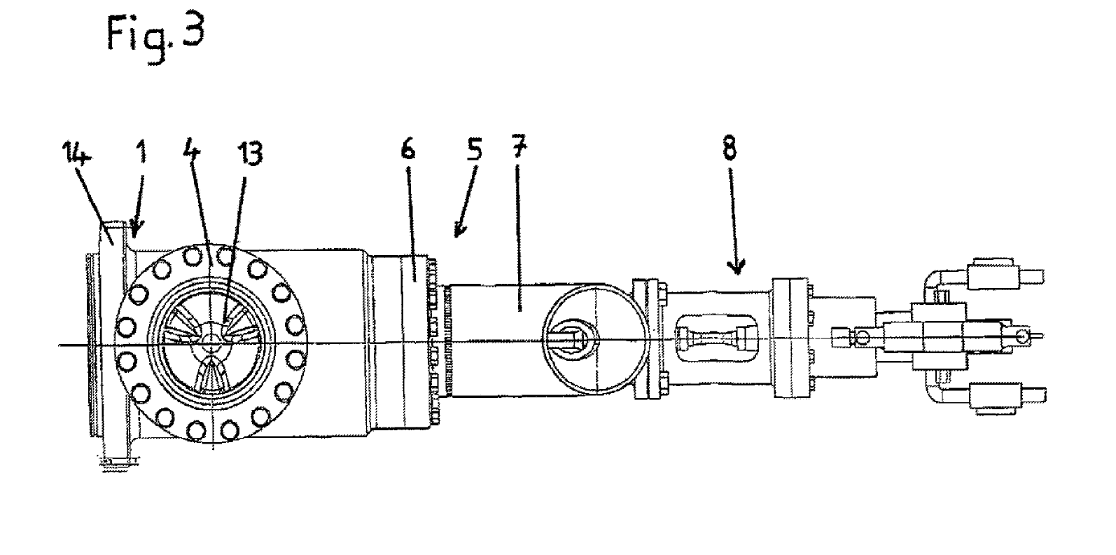

A plan view of the fitting 28 is illustrated in FIG. 3. The liquid flows into the inlet piece 2 through an opening 13 of the component 4. A pipe 30 of the pressure exchanger 29, which is operated in alternating flow directions, is attached to a flange 14 of the connection piece 1.

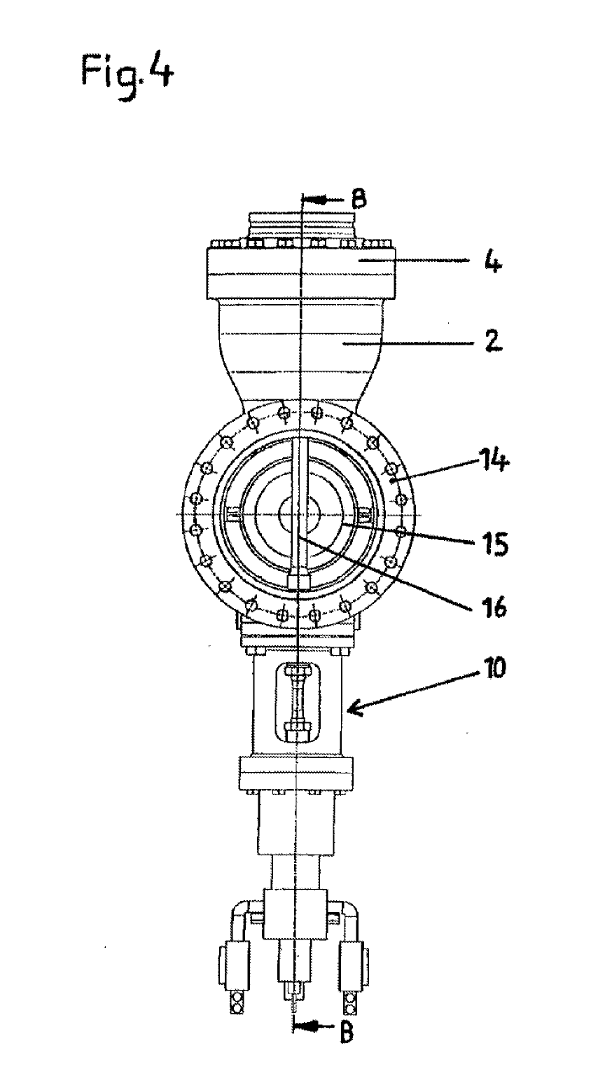

FIG. 4 shows a front view of the changeover fitting. One of the pipes 30 of the pressure exchanger 29 is secured to the flange 14 of the connection piece 1.

The high-pressure liquid flows through the component 4 and the inlet piece 2 into the fitting 28.

During the first cycle, high-pressure retentate flows out from the fitting 28 from an opening 15 of the connection piece 1. During a second cycle, low-pressure retentate flows into the fitting 28 through the opening 15 of the connection piece 1. An adjusting rod 16 of the actuator 10 runs in the flow chamber of the casing 11.

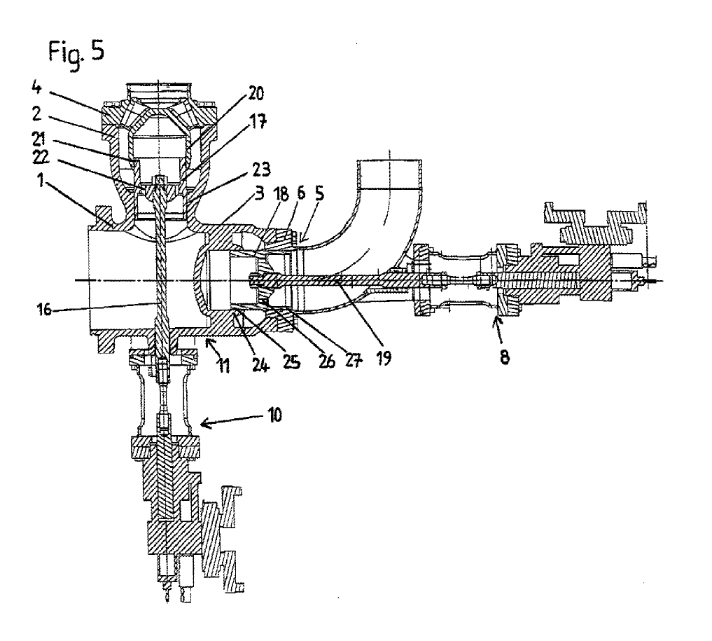

A section along the line B-B according to FIG. 4 is illustrated in FIG. 5. The fitting 28 according to the invention comprises a casing 11, which comprises an inlet piece 2, an outlet piece 3, and a connection piece 1. The connection piece 1 is operated in alternating flow directions. A shut-off member 17, 18 is arranged in each of the inlet piece 2 and outlet piece 3. The shut-off members 17, 18 are each connected to an actuator 8, 10 respectively. The actuators 8, 10 are operable via a control device. Here, a liquid flow occurs either between the inlet piece 2 and the connection piece 1 or between the connection piece 1 and the outlet piece 3. In accordance with the invention, the size of a flow opening can be varied by axial displacement of one of the shut-off members 17, 18.

The core piece of the apparatus according to the invention is the casing 11, which consists of the inlet piece 2, the outlet piece 3, and the connection piece 1. The casing is a one-piece structure here, which is fabricated in the exemplary embodiment as a cast part.

In the inlet piece 2, a shut-off member 17 is arranged and is connected to the actuator 10 via an adjusting rod 16. A shut-off member 18 is arranged in the outlet piece 3 and is connected via an adjusting rod 19 to the actuator 8. The shut-off members 17, 18 are cylindrical. In the exemplary embodiment, these are hollow cylinders that are closed at one end and are thus formed in a beaker-like manner.

The actuators 8, 10 are operable by means of a control device. Here, both actuators 8, 10 are assigned to a common control device. Here, this is preferably a memory-programmable controller. The size of a flow opening is varied by axial displacement of at least one shut-off member 17, 18.

A component 4 is joined to the inlet piece 2 and comprises a guide element 20. The guide element 20 is a hollow cylinder in which the cylindrical shut-off member 17 moves during opening and closing. The shut-off member 17 moves perpendicular to the liquid flow during its axial displacement. The inner diameter of the hollow-cylindrical guide element 20 is slightly greater than the outer diameter of the hollow-cylindrical shut-off member 17.

Seals 21 are arranged between the side walls of the cylindrical shut-off member 17 and the inner surfaces of the hollow-cylindrical guide element 20. The guide element 20 is closed toward the inflow direction and is thus formed in a beaker-like manner.

The cylindrical shut-off member 17 is formed in the exemplary embodiment as a hollow cylinder and has a base with openings 22, through which the liquid enclosed between the shut-off member 17 and guide element 20 can escape during the opening process.

If the shut-off member 17 travels upwardly, a flow opening between the hollow-cylindrical guide element 20 of the component 4 and the casing 11 is thus enlarged. Webs 23 protrude from the shut-off member 17 into the flow opening. In the illustration in FIG. 5, the section passes through these webs 23.

The outlet piece 3 comprises a guide element 24. The guide element 24 is a hollow cylinder. The guide element 24 is formed by the outlet piece 3 of the casing 11. The cylindrical shut-off member 18 moves in the cylindrical guide element 24. The inner diameter of the hollow-cylindrical guide element 24 is slightly greater than the outer diameter of the hollow-cylindrical shut-off member 18. The shut-off member 18 moves perpendicular to the liquid flow during its axial displacement. The guide element 24 is closed toward the inflow direction and is thus formed in a beaker-like manner.

Seals 25 are arranged between the side walls of the beaker-shaped shut-off member 18 and the inner surfaces of the hollow-cylindrical guide element 24. The beaker-shaped shut-off member 18 is provided on its base with openings 26, through which the liquid enclosed between the shut-off member 18 and guide element 24 can escape during the opening process.

A component 5 is joined to the outlet piece 3 and comprises a flange 6. During the opening process, a flow opening between the hollow-cylindrical guide element 24 and the flange 6 is enlarged. The guide element 24 is part of the casing 11. The flange 6 is part of the component 5. The flow opening between the casing 11 and the component 5 is thus formed. Webs 27 protrude from the shut-off member 18 into the flow opening. In the illustration in FIG. 5, the section passes through these webs 27.

The fitting 28 is operated in periodic cycles. In the first cycle, the liquid flow occurs from the inlet piece 2 to the connection piece 1. In the second cycle, the liquid flow occurs from the connection piece 1 to the outlet piece 3.

In the first cycle, the flow opening in the outlet piece 3 is fully closed. During a first phase, the shut-off member 17 in the inlet piece 2 opens. The flow opening in the inlet piece 2 becomes larger until it is fully open. During a second phase, the flow opening in the inlet piece 2 remains fully open. During a third phase, the shut-off member 17 in the inlet piece 2 closes, wherein the size of the flow opening in the inlet piece 2 reduces.

In the second cycle, the flow opening in the inlet piece 2 is fully closed. During a first phase the shut-off member 18 of the outlet piece 3 opens. The flow opening in the outlet piece 3 enlarges. During a second phase, the flow opening of the outlet piece 3 is fully open. During a third phase, the shut-off member 18 of the outlet piece 3 closes, wherein the flow opening in the outlet piece 3 reduces.

FIG. 6 shows a system for seawater desalination in accordance with the reverse osmosis method, having a pressure exchanger 29, which comprises three pipes 30. Three fittings 28 are used in the pressure exchanger 29. By use of the apparatuses according to the invention, it is thus possible to operate a pressure exchanger 29 having an odd number of pipes 30. Each pipe 30 is provided at one end with a fitting 28 according to the invention and at the other end with a check fitting 31, which are formed in the exemplary embodiment as check valves.

The function of the reverse osmosis method for seawater desalination with use of the fittings 28 according to the invention will be described hereinafter on the basis of FIG. 6.

A feed flow of seawater is conveyed to a membrane unit 33 from a reservoir 32. The seawater, before its storage in the reservoir 32 or before being conveyed to the membrane unit 33, is purified of constituents that could damage or soil the semi-permeable membrane.

A reverse osmosis process takes place in the membrane unit 33, in which the seawater is pressed through the membrane at high pressure. Here, the osmotic pressure has to be overcome. The semi-permeable membrane may consist for example of polyamide, PTFE, or sulfonated copolymers having a pore diameter of 5·10⁻⁷ to 5·10⁻⁶ mm. The membrane allows water through and retains the salts. The membrane unit 33 separates the feed flow into a permeate flow and a retentate flow. The permeate flow is largely salt-free pure water. The retentate flow has a salt concentration higher than the conveyed feed flow.

The retentate flow, after the membrane unit 33, flows under high pressure into each of the fittings 28 according to the invention via the inlet pieces 2 thereof.

FIG. 6 illustrates a snapshot in which the shut-off members 17, 18 of the fittings 28 adopt a position in which the low-pressure retentate is pushed out from the middle and lower pipe 30. Here, a shut-off member 17 closes the inlet piece 2 of the lower and middle fitting 28, whereas the shut-off members 18 in the outlet pieces 3 of these two fittings 28 adopt an open position.

At the same time, in the state illustrated in FIG. 6, the lower and middle pipe 30 fill with fresh seawater from the reservoir 32. The seawater is aspirated by a pump 34. Some of the seawater flows into the lower and middle pipe 30 at a branching via check fittings 31.

At the same time as this process, seawater is pushed out from the upper pipe 30. In the case of the fitting 28 that is attached to the upper pipe 30, the inlet piece 2 is open, whereas the outlet piece 3 is closed. The seawater flows through a check fitting 31 and a pump 35 to the membrane unit 33. The feed flow is additionally fed by a flow that is conveyed via a pump 36. Whilst the seawater is displaced from the upper pipe 30, the upper pipe 30 simultaneously fills with high-pressure retentate from the membrane unit 33.

As soon as the seawater has been pushed out completely from a pipe 30, the fitting 28 of said pipe is changed such that the inlet piece 2 is closed and the outlet piece 3 is open. The low-pressure retentate is pushed out from the outlet piece 3. Here, a continuous pulsation-free operation without mixing of fresh seawater and retentate is ensured.

In the exemplary embodiment, seawater and retentate are not separated in the pipes 30 of the pressure exchanger 29 by a partition member.

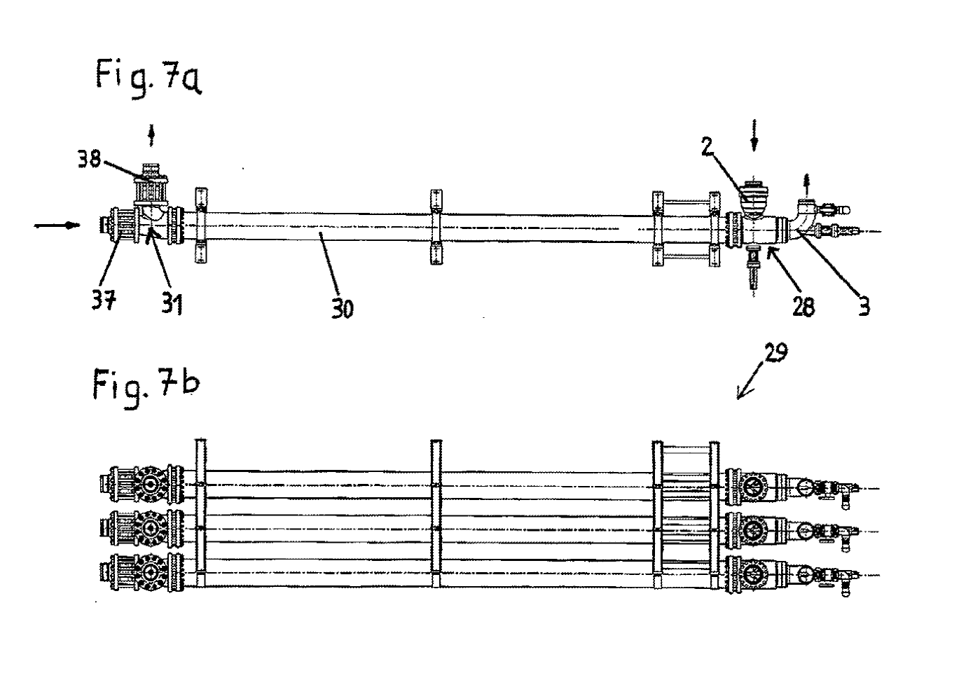

FIGS. 7a and 7b show the pressure exchanger 29 from different perspectives. The pressure exchanger comprises three pipes 30. Each pipe 30 is provided at one end with a fitting 28 according to the invention and at the other end with a check fitting 31. The fittings 28 are connected to the pipes 30 via the connection pieces 1. High-pressure retentate enters the pipes 30 through the inlet pieces 2 of the fittings 28. Low-pressure retentate exits through the outlet piece 3 of the fittings 28.

Each check fitting 31 has an entry 37, through which seawater flows into the respective pipe 30, and an exit 38, through which the seawater located in the pipe 30 is conveyed out.

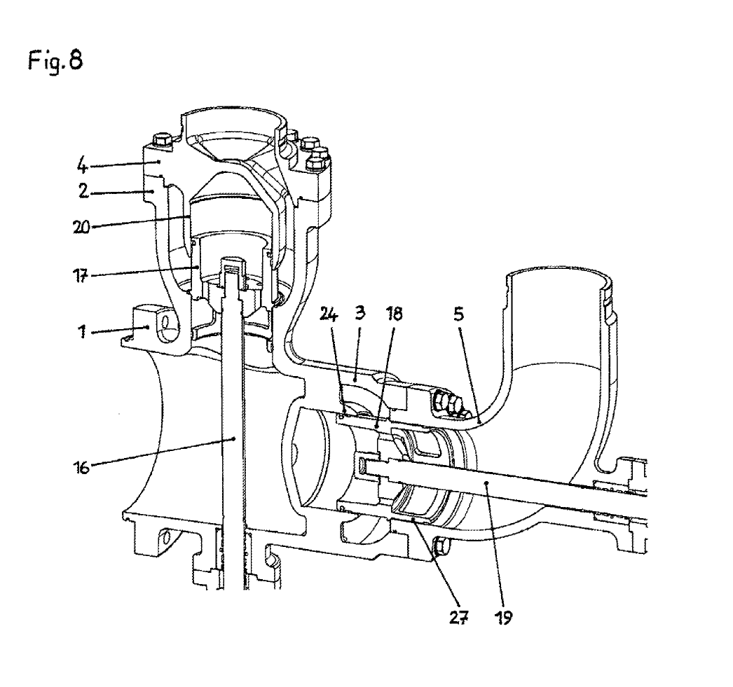

FIG. 8 shows a perspective sectional illustration of the fitting 28. The shut-off member 17 in the inlet piece 2 is axially displaceably guided and is operated by means of an adjusting rod 16.

The actuators 8, 10 are operable by means of a control device. Here, both actuators 8, 10 are assigned to a common control device. Here, the control device is preferably a memory-programmable controller. By axial displacement of at least one shut-off member 17, 18, the size of a flow opening is varied.

A component 4 is joined to the inlet piece 2 and comprises a guide element 20. The guide element 20 is a hollow cylinder in which the shut-off member 17 moves. The shut-off member 17 moves perpendicular to the liquid flow during its axial displacement.

Seals 21 are arranged between the side walls of the cylindrical shut-off member 17 and the inner surfaces of the hollow-cylindrical guide element 20. The beaker-shaped shut-off member 17 is provided on its base with openings 22, through which the liquid enclosed between the shut-off member 17 and guide element 20 can escape during the opening process.

If the shut-off member 17 travels upwardly, a flow opening between the hollow-cylindrical guide element 20 of the component 4 and the casing 11 is thus enlarged. Webs 23 protrude from the shut-off member 17 into the flow opening.

If the shut-off member 17 closes the flow opening of the inlet piece 2, the retentate thus acts perpendicularly on the outer lateral surface of the hollow-cylindrical shut-off member 17. This facilitates the opening of the shut-off member 17, since, in contrast to conventional fittings, no force acts in the movement direction of the shut-off member 17, but perpendicular thereto.

If the shut-off member 17 in the inlet piece 2 is in an open position, the liquid thus flows in radially and flows out axially.

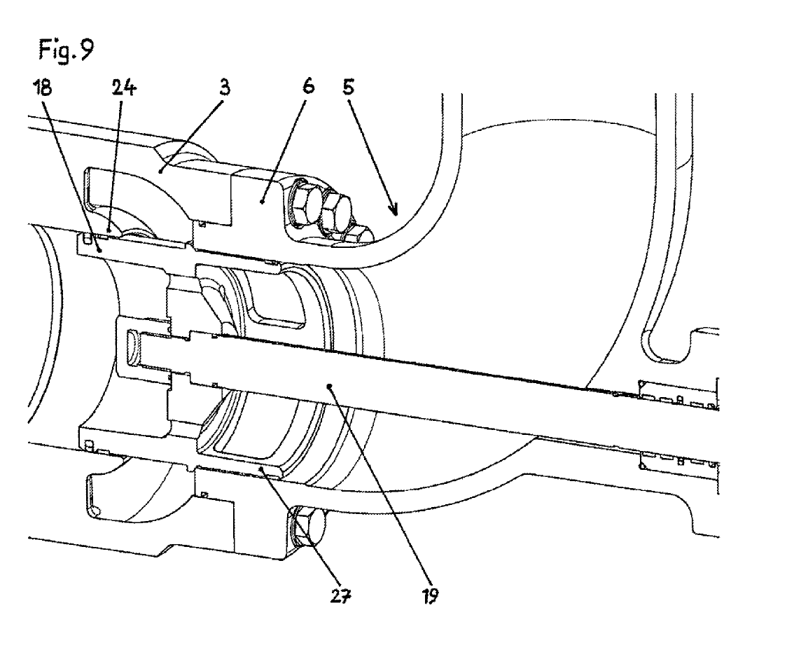

FIG. 9 shows an enlarged illustration of the outlet piece 3 of the fitting 28. The cylindrical shut-off member 18 in the outlet piece 3 is axially displaceably guided and is operated via an adjusting rod 19. The guide element 24 of the outlet piece 3 is a hollow cylinder. The shut-off member 18 moves in the hollow-cylindrical guide element 24. The shut-off member 18, during its axial displacement, moves perpendicular to the liquid flow.

A component 5 is joined to the outlet piece 3 and comprises a flange 6. During the opening process, a flow opening between the hollow-cylindrical guide element 24 and the flange 6 is enlarged. The guide element 24 is part of the casing 11. The flange 6 is part of the component 5. The flow opening between the casing 11 and the component 5 is thus formed. Webs 27 protrude from the shut-off member 18 into the flow opening.

A guide element is formed in the outlet piece 3 by the casing itself. The shut-off member 18 is likewise hollow-cylindrical and moves in the hollow-cylindrical guide element 24. If the shut-off member 18 closes the flow opening in the outlet piece 3, the retentate thus acts perpendicular to the outer lateral surface of the beaker-shaped shut-off member 18. This facilitates the opening of the flow opening, since, in contrast to conventional fittings, no force acts in the movement direction of the shut-off member 18, but perpendicular thereto.

If the shut-off member 18 in the outlet piece 3 is in an open position, the liquid thus flows in radially in relation to the direction of displacement of the shut-off member 18 and then flows on axially.

### LIST OF REFERENCE SIGNS

1 connection piece
2 inlet piece
3 outlet piece
4 component
5 component
6 flange
7 pipe bend
8 actuator
9 holding arrangement
10 actuator
11 casing
12 holding arrangement
13 opening
14 flange
15 opening
16 adjusting rod
17 shut-off member
18 shut-off member
19 adjusting rod
20 guide element
21 seal
22 opening
23 web
24 guide element
25 seal
26 opening
27 web
28 fitting
29 pressure exchanger
30 pipe
31 check fitting
32 reservoir
33 membrane unit
34 pump
35 pump
36 pump
37 entry
38 exit

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-11. (canceled)

12. A fitting for changing liquid paths in systems with a pressure exchanger including at least one pipe configured for alternating flow, comprising:
a casing having an inlet piece, an outlet piece and a connection piece for the at least one pipe;
at least two shut-off members, a first one of the at least two shut-off members being arranged to control flow between the inlet piece and the connection piece, and a second one of the at least two shut-off members being arranged to control flow between the connection piece and the outlet piece; and
at least one actuator configured to be controlled be a control device, each of the at least one actuators being arranged to actuate a respective one of the at least two shut-off members between shut-off and open positions,
wherein the at least two shut-off members are configured such that axial displacement of the shut-off members changes a size of at least one flow opening through which liquid flows when the shut-off members are not in the shut-off position.

13. The fitting as claimed in claim 12, wherein each of the at least two shut-off members is connected to separate actuators.

14. The fitting as claimed in claim 12, wherein at least one component is joined to at least one of the inlet piece and outlet piece, and
the at least one flow opening is located between the connection piece and the at least one component.

15. The fitting as claimed in claim 14, wherein at least two shut-off members are guided during axial displacement by at least one of the casing and the at least one component.

16. The fitting as claimed in claim 12, wherein during axial displacement the at least two shut-off members move perpendicular to the liquid flow through the at least one flow opening.

17. The fitting as claimed in claim 12, wherein at least one of the at least two shut-off members is cylindrical.

18. The fitting as claimed in claim 17, wherein axial displacement of at least one of the at least two shut-off members is guided in a respective cylindrical guide element.

19. The fitting as claimed in claim 18, wherein the respective guide element is closed on a side of the guide element located one an upstream side of the flow through its respective inlet or outlet connection.

20. The fitting as claimed in claim 12, wherein the inlet piece and the outlet piece are oriented perpendicular to one another.

21. A method for operating a fitting for changing liquid paths in systems with a pressure exchanger including at least one pipe configured for alternating flow, the fitting comprising
a casing having an inlet piece, an outlet piece and a connection piece for the at least one pipe;
at least two shut-off members, a first one of the at least two shut-off members being arranged to control flow between the inlet piece and the connection piece, and a second one of the at least two shut-off members being arranged to control flow between the connection piece and the outlet piece; and
at least one actuator configured to be controlled be a control device, each of the at least one actuators being arranged to actuate a respective one of the at least two shut-off members between shut-off and open positions,
wherein the at least two shut-off members are configured such that axial displacement of the shut-off members changes a size of at least one flow opening through which liquid flows when the shut-off members are not in the shut-off position,
the method comprising the acts of:
operating the fitting in a first cycle having first cycle phases, wherein the second one of the at least two shut-off members is in a shut-off position preventing flow through the outlet piece, the first cycle phases comprising:
a first phase of displacing the first one of the at least two shut-off members to a position between the shut-off position and a fully-open position to permit flow through the inlet piece to the connection piece through at least one of the at least one flow openings,
a second phase of displacing the first one of the at least two shut-off members to the fully-open position, and
a third phase of displacing the first one of the at least two shut-off members to the shut-off position; and
operating the fitting in a second cycle having second cycle phases, wherein the first one of the at least two shut-off members is in a shut-off position preventing flow through the inlet piece, the second cycle phases comprising:
a first phase of displacing the second one of the at least two shut-off members to a position between the shut-off position and a fully-open position to permit flow from the connection piece through the outlet piece through at least another one of the at least one flow openings,
a second phase of displacing the second one of the at least two shut-off members to the fully-open position, and
a third phase of displacing the second one of the at least two shut-off members to the shut-off position.

22. The method as claimed in claim 21, wherein, in at least one of the first and third phases of the cycles, a speed of displacement of the respective first and second shut-off members initially rises with a predefined gradient and then continues with constant speed.
